(19) United States
(12) Patent Application Publication
(10) Pub. No.: US 2026/0142055 A1
(43) Pub. Date: May 21, 2026

(54) COMMUNICATION SYSTEM

(71) Applicant: CANON KABUSHIKI KAISHA, Tokyo (JP)

(72) Inventor: TAKAYA NISHIZAWA, Kanagawa (JP)

(21) Appl. No.: 19/377,273

(22) Filed: Nov. 3, 2025

(30) Foreign Application Priority Data
Nov. 15, 2024 (JP) 2024-199963

(51) Int. Cl. H01B 5/00; H01P 3/08

(52) U.S. Cl. CPC H01B 5/002; H01P 3/081

(57) ABSTRACT

Provided is a communication system that includes a first electrode, and a second electrode that couples to the first electrode by using an electric field, a magnetic field, or electric and magnetic fields. The second electrode has two or more bent portions in a predetermined direction, and a distance between farthest points of the second electrode in a direction perpendicular to the predetermined direction is longer than a distance between farthest points of the first electrode in a direction perpendicular to the predetermined direction.

### BACKGROUND

### Field of the Technology

The present disclosure relates to a communication system.

### Description of the Related Art

With advances in wireless communication technology using electromagnetic field coupling, a system for performing high-speed data transmission has been proposed. According to such a system, wiring of a portion corresponding to parallel movement or rotation in a production system or an apparatus such as a robot apparatus is made wireless. An example of technology for short range wireless communication corresponding to the parallel movement includes a method for performing short range wireless communication between coupled transmission lines as discussed in Japanese Patent Laid-Open No. 2014-33432.

### SUMMARY

The present disclosure is directed to enabling high-quality communication, even in a case where a positional relation between a first electrode and a second electrode is shifted.

An aspect of the present disclosure provides a communication system that includes a first electrode extending in a predetermined direction and a second electrode extending in the predetermined direction, the second electrode being configured to couple to the first electrode by at least one electric field and/or magnetic field. The second electrode has two or more bent portions, the two or more bent portions being bent in a direction perpendicular to the predetermined direction. A distance between farthest points of the second electrode in the direction perpendicular to the predetermined direction is longer than a distance between farthest points of the first electrode in the direction perpendicular to the predetermined direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration of a wireless communication system according to a first embodiment.

FIG. 2 is a diagram illustrating a specific configuration example of the wireless communication system according to the first embodiment.

FIGS. 3A to 3C are diagrams illustrating operation principles of the wireless communication system according to the first embodiment.

FIGS. 4A to 4C are diagrams illustrating operation principles of the wireless communication system according to the first embodiment.

FIGS. 5A to 5D are diagrams illustrating operation principles of the wireless communication system according to the first embodiment.

FIGS. 6A to 6C are diagrams each illustrating a simulation result of operation of the wireless communication system according to the first embodiment.

FIGS. 7A to 7C are diagrams each illustrating a simulation result of operation of the wireless communication system according to the first embodiment.

FIGS. 8A to 8C are diagrams each illustrating operation of the wireless communication system according to the first embodiment.

FIGS. 9A to 9C are diagrams each illustrating a simulation result of operation of the wireless communication system according to the first embodiment.

FIGS. 10A and 10B are diagrams each illustrating a specific configuration example of the wireless communication system according to the first embodiment.

FIG. 11 is a diagram illustrating a configuration of a wireless communication system according to a second embodiment.

FIGS. 12A to 12C are diagrams each illustrating a specific configuration example of the wireless communication system according to the second embodiment.

FIGS. 13A to 13C are diagrams each illustrating a simulation result of operation of the wireless communication system according to the second embodiment.

FIGS. 14A to 14C are diagrams each illustrating operation of the wireless communication system according to the second embodiment.

### DESCRIPTION OF THE EMBODIMENTS

Hereinafter, various embodiments to which the present disclosure is applicable are described in detail with reference to the drawings. In the following description, components common to one or more drawings are given common reference codes. The common components are described by referring to at least one the plurality of the drawings. For conciseness, description of the components having the common reference codes is incorporated by reference without being repeated.

### First Embodiment

A first embodiment of the present disclosure is described.

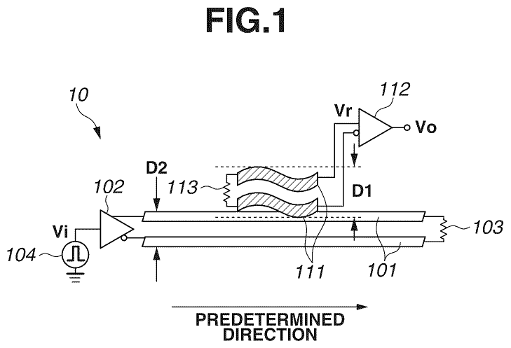

FIG. 1 is a diagram schematically illustrating a configuration of a wireless communication system 10 according to the first embodiment.

The wireless communication system 10, as illustrated in FIG. 1, includes a transmission electrode 101, a buffer 102, a terminator 103, a transmission signal source 104, a reception electrode 111, a reception circuit 112, and a terminator 113.

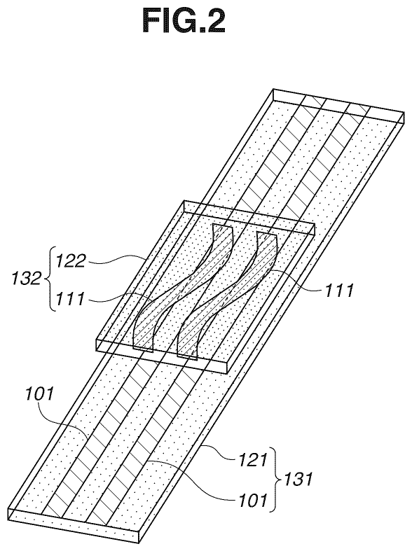

As illustrated in FIG. 2, a transmission coupler 131 includes the transmission electrode 101 of a differential line and a ground conductor 121. The transmission coupler 131 is formed on, for example, a printed-circuit board.

The transmission signal source 104 generates a single-end transmission signal Vi, and is connected to the buffer 102.

The buffer 102 receives the single-end transmission signal Vi generated by the transmission signal source 104, and outputs a differential transmission signal to the transmission electrode 101.

The buffer 102 is connected to one end of the transmission electrode 101, so that the transmission electrode 101 receives the differential transmission signal generated by the buffer 102 and outputs a wireless differential transmission signal.

The terminator 103 is connected to the other end of the transmission electrode 101. The other end of the transmission electrode 101 is an end to which the buffer 102 is not connected. The terminator 103 terminates a transmission line in a matching manner.

As illustrated in FIG. 2, a reception coupler 132 includes the reception electrode 111 of a differential line and a ground conductor 122. The reception coupler 132 is formed on, for example, a printed-circuit board. The reception electrode 111 is coupled to the transmission electrode 101 by using an electromagnetic field, and receives a wireless differential received signal from the transmission electrode 101.

Herein, the reception electrode 111 can be coupled to the transmission electrode 101 by using an electric field, a magnetic field, or electric and magnetic fields.

The reception circuit 112 is connected to one end of the reception electrode 111. The reception circuit 112 processes a differential received signal Vr received by the reception electrode 111, and outputs a single-end signal Vo.

The terminator 113 is connected to the other end of the reception electrode 111, and terminates a transmission line in a matching manner. The other end of the reception electrode 111 is an end to which the reception circuit 112 is not connected.

As illustrated in FIG. 1, the transmission electrode 101 is longer than the reception electrode 111 in the predetermined direction. A unit is provided to laterally shift the reception electrode 111 to change a positional relation between a center of the reception electrode 111 and a center of the transmission electrode 101 with respect to a horizontal direction perpendicular to the predetermined direction (hereinafter a lateral shift) while maintaining a vertical distance between the reception electrode 111 and the transmission electrode 101. The reception electrode 111 performs wireless communication while moving. The transmission electrode 101 and the reception electrode 111 are relatively movable in the direction perpendicular to the predetermined direction.

The reception electrode 111, as illustrated in FIG. 1, has a meandering shape with a plurality of bent portions along the predetermined direction. A distance D1 between farthest points of the reception electrode 111 in a direction perpendicular to the predetermined direction is longer than a distance D2 between farthest points of the transmission electrode 101 in the direction perpendicular to the predetermined direction. The transmission electrode 101 has a linear shape.

FIG. 2 is a diagram illustrating a configuration example of a transmission line according to the first embodiment. Each of the transmission coupler 131 and the reception coupler 132 is formed on respective printed-circuit boards.

The transmission coupler 131 includes the ground conductor 121 and the transmission electrode 101 of a differential line. The ground conductor 121 is arranged on the bottom surface of the printed-circuit board, whereas the transmission electrode 101 is arranged on the top surface of the printed-circuit board. The reception coupler 132 includes the ground conductor 122 and the reception electrode 111 of a differential line. The ground conductor 122 is arranged on the top surface of the printed-circuit board, whereas the reception electrode 111 is arranged on the bottom surface of the printed-circuit board.

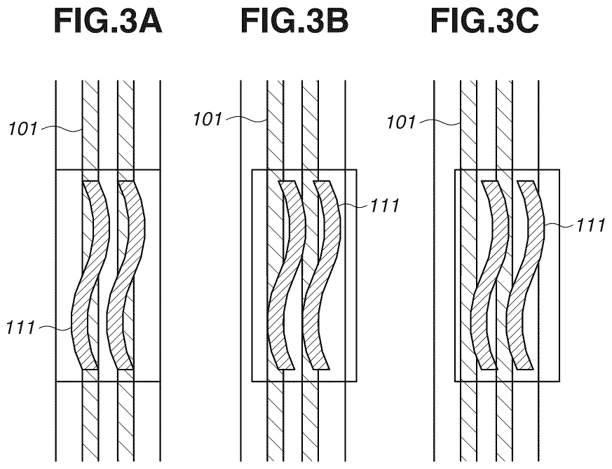

FIGS. 3A through 3C illustrate the transmission line illustrated in FIG. 2, viewed from above the reception electrode 111. FIG. 3A illustrates a state in which the transmission electrode 101 and the reception electrode 111 face each other without a lateral shift. FIG. 3B illustrates a state in which the transmission electrode 101 and the reception electrode 111 face each other with a small lateral shift amount. FIG. 3C illustrates a state in which the transmission electrode 101 and the reception electrode 111 face each other with a large lateral shift amount.

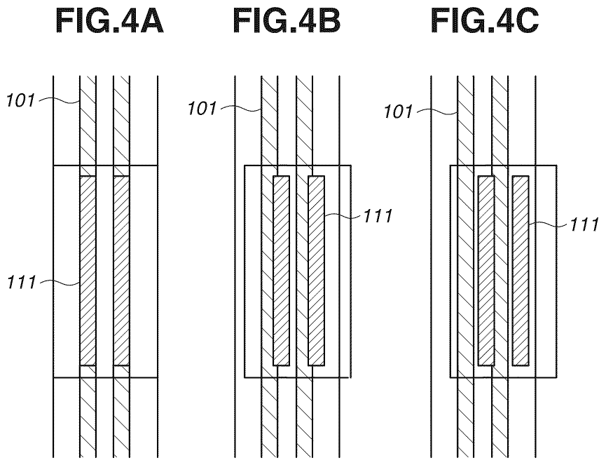

FIGS. 4A through 4C illustrate a transmission line, viewed from above the reception electrode 111 in a case where the reception electrode 111 is not bent. The transmission electrode 101 and the reception electrode 111 illustrated in FIGS. 4A through 4C are formed of differential lines having equal impedances on substrates having the same thickness as substrates on which the transmission electrode 101 and the reception electrode 111 illustrated in FIGS. 3A through 3C are formed. The differential lines have the same width and the same space therebetween.

FIG. 4A illustrates a state in which the transmission electrode 101 and the reception electrode 111 face each other without a lateral shift. FIG. 4B illustrates a state in which the transmission electrode 101 and the reception electrode 111 face each other with a small lateral shift amount. FIG. 4C illustrates a state in which the transmission electrode 101 and the reception electrode 111 face each other with a large lateral shift amount.

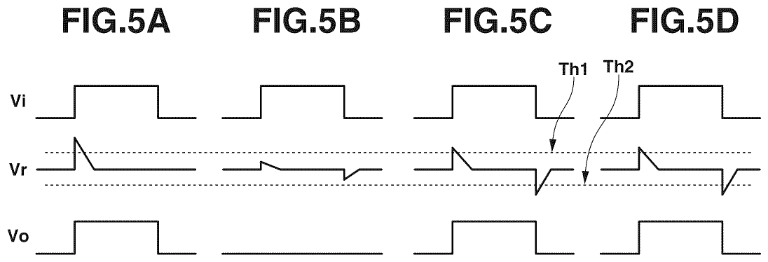

FIGS. 5A through 5D are diagrams illustrating waveforms of a single-end transmission signal Vi, a received signal Vr, and an output signal Vo in the wireless communication system 10. Each of threshold values Th1 and Th2 indicated by dotted lines illustrated in FIGS. 5A through 5D is one example of a comparator threshold value of the reception circuit 112. The single-end transmission signal Vi is generated by the transmission signal source 104. The received signal Vr is received by the reception electrode 111. The output signal Vo is output from the reception circuit 112, and has a waveform that is a rollback of the single-end transmission signal Vi based on the received signal Vr. The reception circuit 112 rolls back the single-end transmission signal Vi based on a differential received signal received by the reception electrode 111, and outputs an output signal Vo.

With the received signal Vr greater than the threshold value Th1, the reception circuit 112 maintains the output signal Vo at a high level. With the received signal Vr becomes less than the threshold value Th2, the reception circuit 112 maintains the output signal Vo at a low level.

FIG. 5A illustrates a waveform when the reception electrode 111 having a linear shape and the transmission electrode 101 face each other without a lateral shift, as illustrated in FIG. 4A. FIG. 5B illustrates one example of a waveform when the reception electrode 111 having the linear shape and the transmission electrode 101 face each other with a lateral shift, as illustrated in FIG. 4C.

FIG. 5C illustrates a waveform when the reception electrode 111 having the bent portion according to the present embodiment and the transmission electrode 101 face each other without a lateral shift, as illustrated in FIG. 3A. FIG. 5D illustrates a waveform when the reception electrode 111 having the bent portion according to the present embodiment and the transmission electrode 101 face each other, as illustrated in FIG. 3C, with FIG. 3C and FIG. 5B having the same amount of lateral shift.

As illustrated in FIGS. 5A and 5B, in the reception electrode 111 having the linear shape, the received signal Vr becomes smaller as the transmission electrode 101 and the reception electrode 111 are laterally shifted from each other, and a waveform of the received signal Vr eventually is no longer detected by a comparator of the reception circuit 112. Such a case occurs due to a weakening of the coupling between the transmission electrode 101 and the reception electrode 111, as an increase in the lateral shift decreases an area where the transmission electrode 101 and the reception electrode 111 face each other as illustrated in FIGS. 4A through 4C.

On the other hand, as illustrated in FIGS. 5C and 5D, in the reception electrode 111 having the bent portion according to the present embodiment, the received signal Vr does not become smaller, even if the transmission electrode 101 and the reception electrode 111 are laterally shifted from each other. Thus, a waveform of the received signal Vr can be readily detected. Since the reception electrode 111 is bent, as illustrated in FIGS. 3A through 3C, an amount of reduction of the area where the transmission electrode 101 and the reception electrode 111 face each other when a lateral shift occurs is reduced, and a coupling state of the transmission electrode 101 and the reception electrode 111 is maintained.

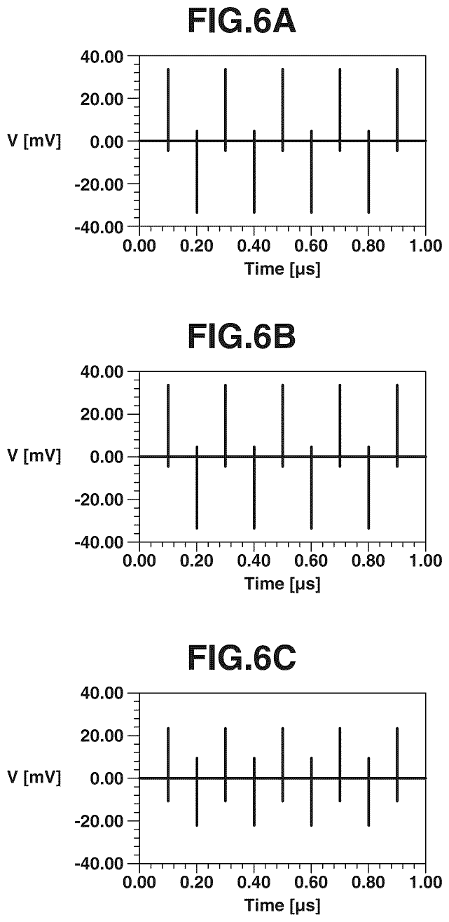

FIGS. 6A through 6C are diagrams each illustrating a result of analysis on a waveform of the received signal Vr based on an electromagnetic field simulation with respect to the transmission line illustrated in FIGS. 3A through 3C. FIGS. 6A, 6B, and 6C are analysis results corresponding to the states illustrated in FIGS. 3A, 3B, and 3C, respectively. In a case where there is no lateral shift in FIG. 6A, a peak value of the received signal Vr is approximately 34 mV. In a case where the lateral shift is small in FIG. 6B, a peak value of the received signal Vr is approximately 34 mV. In a case where the lateral shift is large in FIG. 6C, a peak value of the received signal Vr is approximately 24 mV. In this case, the received signal Vr can be detected as long as absolute values of threshold values Th1 and Th2 of the comparator are set to 20 mV or around 20 mV.

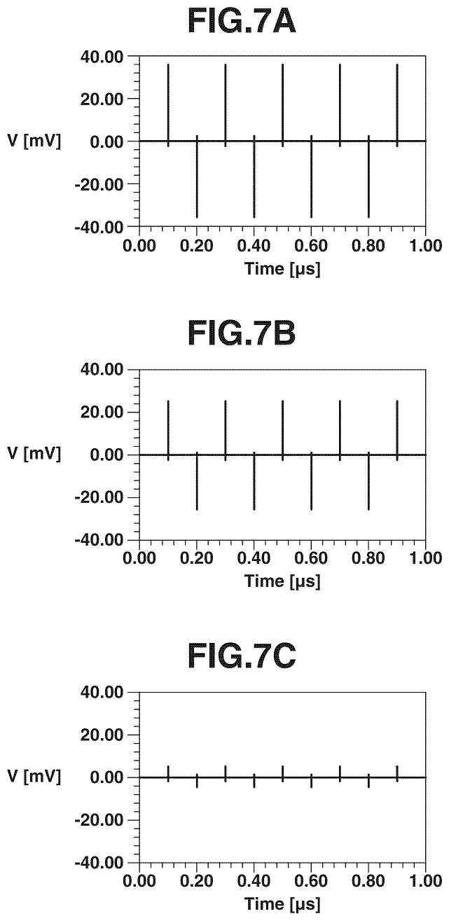

FIGS. 7A through 7C are diagrams each illustrating a result of analysis on a waveform of the received signal Vr based on an electromagnetic field simulation with respect to the transmission line illustrated in FIGS. 4A through 4C. FIGS. 7A, 7B, and 7C are analysis results corresponding to the states illustrated in FIGS. 4A, 4B, and 4C, respectively. In a case where there is no lateral shift in FIG. 7A, a peak value of the received signal Vr is approximately 36 mV. In a case where the lateral shift is small in FIG. 7B, a peak value of the received signal Vr is approximately 26 mV. In a case where the lateral shift is large in FIG. 7C, a peak value of the received signal Vr is approximately 6 mV. In this case, setting of threshold values Th1 and Th2 of the comparator is difficult, and the received signal Vr is unlikely to be accurately detected.

The above results indicate that a shape of the reception electrode 111 having a bent portion provides an effect of decreasing an amount of reduction of the received signal Vr when a lateral shift occurs.

As illustrated in each of FIGS. 3A through 3C, the reception electrode 111 has two or more bent portions, relative to the predetermined direction.

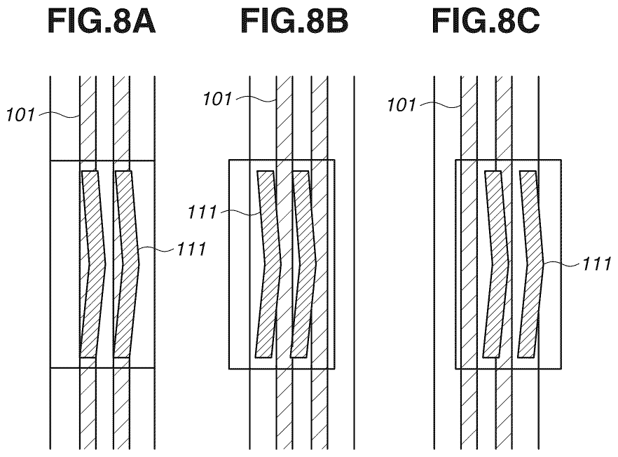

FIGS. 8A through 8C illustrate a transmission line, viewed from above the reception electrode 111 in a case where the reception electrode 111 has only one bent portion in the transmission line illustrated in FIG. 2. FIG. 8A illustrates a state in which the transmission electrode 101 and the reception electrode 111 face each other without a lateral shift. FIG. 8B illustrates a state in which the reception electrode 111 faces the transmission electrode 101 with the reception electrode 111 laterally shifted in a left direction that is a direction in which the reception electrode 111 is not bent. FIG. 8C illustrates a state in which the reception electrode 111 faces the transmission electrode 101 with the reception electrode 111 laterally shifted in a right direction that is a direction in which the reception electrode 111 is bent.

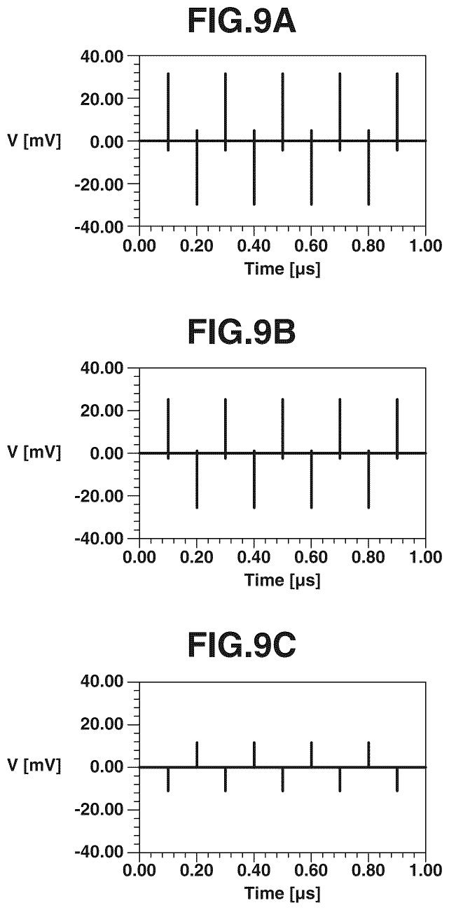

FIGS. 9A through 9C are diagrams each illustrating a result of analysis on a waveform of the received signal Vr based on an electromagnetic field simulation with respect to the transmission line illustrated in FIGS. 8A through 8C. FIGS. 9A, 9B, and 9C are analysis results corresponding to the states illustrated in FIGS. 8A, 8B, and 8C, respectively. In a case where there is no lateral shift in FIG. 9A, a peak value of the received signal Vr is approximately 32 mV. In a case where the reception electrode 111 is laterally shifted leftward in FIG. 9B, a peak value of the received signal Vr is approximately 30 mV. In a case where the reception electrode 111 is laterally shifted rightward in FIG. 9C, an inversed received-signal Vr is acquired.

The above results indicate that the coupling between the transmission electrode 101 and the reception electrode 111 may be weakened depending on a direction of lateral shift, and the received signal Vr may be reduced or inversed if the reception electrode 111 has only one bent portion.

Accordingly, a reception electrode 111 with two or more bent portions is provided.

From the above results, the formation of the reception electrode 111 with a transmission line having a bent portion provides an effect of enhancing a strength against lateral shift without changing a substrate. Thus, a thickness of an antenna can be reduced.

In the predetermined direction, the reception electrode 111 is shorter than the transmission electrode 101. The present embodiment has been described using the case in which an electrode having a length that is shorter in the predetermined direction is the reception electrode 111 and an electrode having a length that is longer in the predetermined direction is the transmission electrode 101. However, a short coupler may be a transmission coupler, and a long coupler may be a transmission coupler.

The present embodiment has been described using the case in which each of the transmission coupler 131 and the reception coupler 132 includes a transmission line that is a differential line. However, the transmission line can be a microstrip line or a coplanar line with a ground. If the coplanar line with the ground is used, a shape of a ground conductor arranged on the same plane as the transmission line has a bent portion as similar to the transmission line.

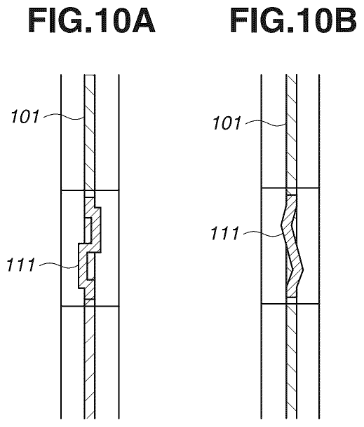

The present embodiment has been described using the case in which the transmission line has a meandering shape that forms a sin curve (a sinusoidal wave). However, the meandering shape is not so limited. FIGS. 10A and 10B are diagrams each illustrating the transmission line of the reception electrode 111 having a meandering shape that can obtain the effect of the present embodiment.

According to the first embodiment, even in a case where the transmission electrode 101 and the reception electrode 111 are laterally shifted from each other, the coupling between the transmission electrode 101 and the reception electrode 111 can be maintained, thereby providing the thin wireless communication system 10 by which stable communication can be performed.

### Second Embodiment

The first embodiment has been described using the case in which the coupler having a shorter length in a predetermined direction is formed of a transmission line having a bent portion. The second embodiment is described using a case in which an effect similar to that of the first embodiment is obtained when a coupler having a longer length in a predetermined direction has a bent portion.

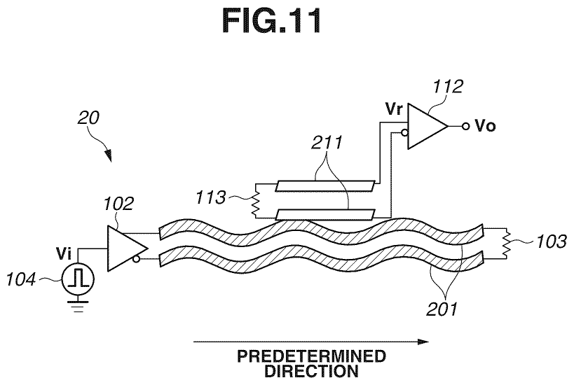

FIG. 11 is a diagram schematically illustrating a configuration of a wireless communication system 20 according to the second embodiment. In FIG. 11, components having functions similar to functions of the components illustrated in FIG. 1 have the same reference codes and the detailed descriptions thereof is incorporated by reference without being repeated.

As illustrated in FIG. 11, the wireless communication system 20 includes a transmission electrode 201, a buffer 102, a terminator 103, a transmission signal source 104, a reception electrode 211, a reception circuit 112, and a terminator 113.

A transmission coupler includes the transmission electrode 201 of a differential line and a ground conductor, and is formed on, for example, a printed-circuit board.

The transmission signal source 104 is connected to the buffer 102.

The buffer 102 is connected to one end of the transmission electrode 201, and the terminator 103 is connected to the other end of the transmission electrode 201.

A reception coupler includes the reception electrode 211 of a differential line and a ground conductor, and is formed on, for example, a printed-circuit board. The reception electrode 211 is coupled to the transmission electrode 201 by using an electromagnetic field, and receives a wireless signal generated by the transmission electrode 201.

The reception circuit 112 is connected to one end of the reception electrode 211.

The terminator 113 is connected to the other end of the reception electrode 211. The other end of the reception electrode 211 is an end to which the reception circuit 112 is not connected.

The buffer 102 receives a single-end transmission signal Vi, and outputs a differential transmission signal to the transmission electrode 201. The transmission electrode 201 is an electrode of a differential line for transmitting a differential transmission signal. The reception electrode 211 is an electrode of a differential line for receiving a differential received signal Vr. The reception circuit 112 rolls back the single-end transmission signal Vi based on the differential received signal Vr received by the reception electrode 211.

As illustrated in FIG. 11, the transmission electrode 201 is longer than the reception electrode 211 in the predetermined direction. A unit is provided to laterally shift the reception electrode 211 while maintaining the vertical distance between the reception electrode 211 and the transmission electrode 201. The reception electrode 211 performs wireless communication while moving. The transmission electrode 201 and the reception electrode 211 are relatively movable in the direction perpendicular to the predetermined direction.

The transmission electrode 201, as illustrated in FIG. 11, has a meandering shape having a plurality of bent portions along the predetermined direction. A distance between farthest points of the transmission electrode 201 in the direction perpendicular to the predetermined direction is longer than a distance between farthest points of the reception electrode 211 in the direction perpendicular to the predetermined direction. The reception electrode 211 has a linear shape. In the predetermined direction, the reception electrode 211 is shorter than the transmission electrode 201.

The transmission electrode 201 has a first bent portion, a second bent portion, and a third bent portion. A distance between the first bent portion and the second bent portion in the predetermined direction is substantially the same as a distance between the second bent portion and the third bent portion in the predetermined direction.

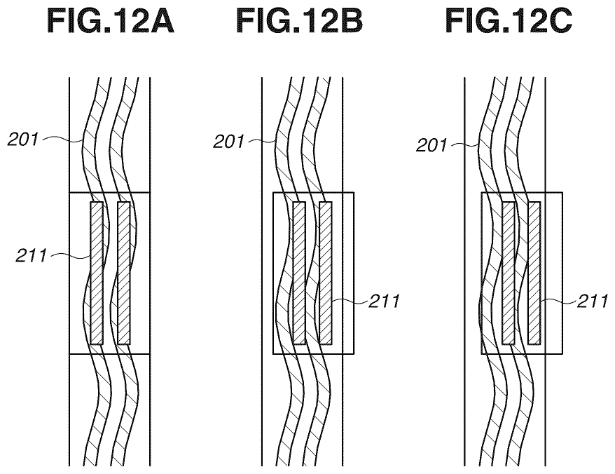

FIGS. 12A through 12C are diagrams each illustrating a configuration example of a transmission line according to the second embodiment. Each of the transmission coupler and the reception coupler are formed on respective printed-circuit boards. The transmission coupler includes the transmission electrode 201 of a differential line and a ground conductor. The reception coupler includes the reception electrode 211 of a differential line and a ground conductor.

FIG. 12A illustrates a state in which the transmission electrode 201 and the reception electrode 211 face each other without a lateral shift. FIG. 12B illustrates a state in which the transmission electrode 201 and the reception electrode 211 face each other with a small lateral shift amount. FIG. 12C illustrates a state in which the transmission electrode 201 and the reception electrode 211 face each other with a large lateral shift amount.

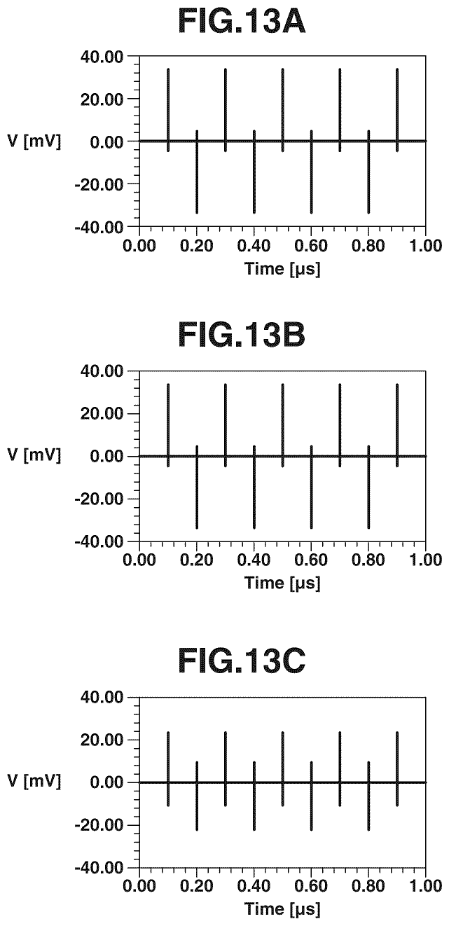

FIGS. 13A through 13C are diagrams each illustrating a result of analysis on a waveform of a received signal Vr based on an electromagnetic field simulation with respect to the transmission line illustrated in FIGS. 12A through 12C. FIGS. 13A, 13B, and 13C are analysis results corresponding to states illustrated in FIGS. 12A, 12B, and 12C respectively. In a case where there is no lateral shift in FIG. 13A, a peak value of the received signal Vr is approximately 34 mV. In a case where the lateral shift is small in FIG. 13B, a peak value of the received signal Vr is approximately 36 mV. In a case where the lateral shift is large in FIG. 13C, a peak value of the received signal Vr is approximately 24 mV. In this case, the received signal Vr can be detected as long as absolute values of threshold values Th1 and Th2 of the comparator are set to 20 mV or around 20 mV.

The above results indicate that the formation of the transmission electrode 201 having a bent portion provides an effect of reducing an amount of reduction of the received signal Vr when a lateral shift occurs.

The transmission electrode 201 has two or more bent portions, and a length of the reception electrode 211 in the predetermined direction is longer than a length including the two bent portions of the transmission electrode 201 in the predetermined direction.

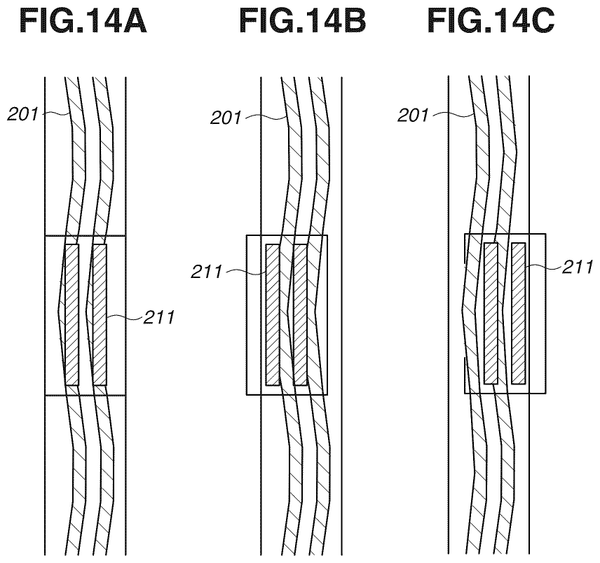

FIGS. 14A through 14C illustrate a transmission line, viewed from above the reception electrode 211 in a case where the reception electrode 211 has a length including only one bent portion of the transmission electrode 201 in the second embodiment. FIG. 14A illustrates a state in which the transmission electrode 201 and the reception electrode 211 face each other without a lateral shift. FIG. 14B illustrates a state in which the transmission electrode 201 and the reception electrode 211 face each other with the reception electrode 211 laterally shifted in a left direction. FIG. 14C illustrates a state in which the transmission electrode 201 and the reception electrode 211 face each other with the reception electrode 211 laterally shifted in a right direction.

As illustrated in FIGS. 14A through 14C, the reception electrode 211 has a length including only one bent portion of the transmission electrode 201. In such a case, a positional relation between the reception electrode 211 and the transmission electrode 201 in the predetermined direction enables the coupling between the reception electrode 211 and the transmission electrode 201 to be maintained when a lateral shift occurs in one direction. However, the coupling cannot be maintained when a lateral shift occurs in the other direction. Accordingly, a the transmission electrode 201 with two or more bent portions is provided, and a length of the reception electrode 211 in the predetermined direction is a length including two bent portions of the transmission electrode 201 in the predetermined direction or longer.

According to the second embodiment, even in a case where the transmission electrode 201 and the reception electrode 211 are laterally shifted from each other, the coupling between the transmission electrode 201 and the reception electrode 211 can be maintained, thereby providing the thin wireless communication system 20 by which stable communication can be performed.

According to each of the first and second embodiments, thin transmission coupler and reception coupler are provided, enabling the coupling between the transmission coupler and the reception coupler to be maintained even in a case where a lateral shift occurs, and communication quality is enhanced.

While each of the embodiments has been described, it is to be understood that the description of each embodiment is intended to illustrate a specific example of the present disclosure, and not intended to limit the technical scope of the present disclosure. That is, various modifications and enhancement are possible without departing from the technical concept or main characteristics of the present disclosure.

The disclosure of each of the embodiments includes the following configurations.

### (Item 1)

A communication system includes a first electrode extending in a predetermined direction and a second electrode extending in the predetermined direction and configured to couple to the first electrode by at least one electric field and/or magnetic field. The second electrode includes two or more bent portions, the two or more bent portions being bent in a in a direction perpendicular to the predetermined direction, and a distance between farthest points of the second electrode in the direction perpendicular to the predetermined direction is longer than a distance between farthest points of the first electrode in the direction perpendicular to the predetermined direction.

### (Item 2)

In the communication system in the item 1, the first electrode has a linear shape

### (Item 3)

In the communication system in the item 1 or 2, the second electrode has a meandering shape.

### (Item 4)

In the communication system in any one of the items 1 through 3, the two or more bent portions of the second electrode include a first bent portion, a second bent portion, and a third bent portion, and a distance between the first bent portion and the second bent portion in the predetermined direction is substantially same as a distance between the second bent portion and the third bent portion in the predetermined direction.

### (Item 5)

In the communication system in any one of the items 1 through 4, the first electrode is an electrode of a differential line, and the second electrode is an electrode of a differential line.

### (Item 6)

In the communication system in any one of the items 1 through 5, a first coupler and a second coupler are further included. The first coupler includes the first electrode and a first ground conductor, and the second coupler includes the second electrode and a second ground conductor.

### (Item 7)

In the communication system in the item 6, the first coupler is a microstrip line, and the second coupler is a microstrip line.

### (Item 8)

In the communication system in the item 6, the first coupler is a coplanar line, and the second coupler is a coplanar line.

### (Item 9)

In the communication system in any one of the items 1 through 8, the first electrode and the second electrode are relatively movable in the direction perpendicular to the predetermined direction.

### (Item 10)

In the communication system in any one of the items 1 through 9, the first electrode is a transmission electrode, and the second electrode is a reception electrode.

### (Item 11)

In the communication system in any one of the items 1 through 10, the second electrode is shorter than the first electrode, in the predetermined direction.

### (Item 12)

In the communication system in the item 10, the transmission electrode is an electrode of a differential line configured to transmit a differential transmission signal, the reception electrode is an electrode of a differential line configured to receive a differential received signal, and the communication system further includes a buffer and reception circuit. The buffer is configured to receive a single-end transmission signal and output the differential transmission signal to the transmission electrode, and the reception circuit configured to roll back the single-end transmission signal based on the differential received signal received by the reception electrode.

### (Item 13)

In the communication system in any one of the items 1 through 9, the first electrode is a reception electrode, and the second electrode is a transmission electrode.

### (Item 14)

In the communication system in any one of the items 1 through 10 and 13, the first electrode is shorter than the second electrode, in the predetermined direction.

### (Item 15)

In the communication system in the item 14, a length of the first electrode in the predetermined direction is equal to or longer than a length between two bent portions of the second electrode in the predetermined direction.

### (Item 16)

In the communication system in the item 13, the transmission electrode is an electrode of a differential line configured to transmit a differential transmission signal, the reception electrode is an electrode of a differential line configured to receive a differential received signal, and the communication system further includes a buffer and a reception circuit. The buffer configured to receive a single-end transmission signal and output the differential transmission signal to the transmission electrode, and the reception circuit configured to roll back the single-end transmission signal based on the differential received signal received by the reception electrode.

According to the present disclosure, high-quality communication can be performed even in a case where a positional relation between a first electrode and a second electrode is shifted.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-199963, filed Nov. 15, 2024, which is hereby incorporated by reference herein in its entirety.

What is claimed is:

1. A communication system comprising:
a first electrode extending in a predetermined direction; and
a second electrode extending in the predetermined direction and configured to couple to the first electrode by at least one electric field and/or magnetic field,
wherein the second electrode has two or more bent portions, the two or more bent portions being bent in a direction perpendicular to the predetermined direction, and
wherein a distance between farthest points of the second electrode in the direction perpendicular to the predetermined direction is longer than a distance between farthest points of the first electrode in the direction perpendicular to the predetermined direction.

2. The communication system according to claim 1, wherein the first electrode has a linear shape.

3. The communication system according to claim 1, wherein the second electrode has a meandering shape.

4. The communication system according to claim 1,
wherein the first electrode is an electrode of a differential line, and
wherein the second electrode is an electrode of a differential line.

5. The communication system according to claim 1, further comprising:
a first coupler including the first electrode and a first ground conductor; and
a second coupler including the second electrode and a second ground conductor.

6. The communication system according to claim 5,
wherein the first coupler is a microstrip line, and
wherein the second coupler is a microstrip line.

7. The communication system according to claim 5,
wherein the first coupler is a coplanar line, and
wherein the second coupler is a coplanar line.

8. The communication system according to claim 1, wherein the first electrode and the second electrode are relatively movable in the direction perpendicular to the predetermined direction.

9. The communication system according to claim 1,
wherein the first electrode is a transmission electrode, and
wherein the second electrode is a reception electrode.

10. The communication system according to claim 1, wherein the second electrode is shorter than the first electrode, in the predetermined direction.

11. The communication system according to claim 9,
wherein the transmission electrode is an electrode of a differential line configured to transmit a differential transmission signal,
wherein the reception electrode is an electrode of a differential line configured to receive a differential received signal, and
wherein the communication system further comprises:
a buffer configured to receive a single-end transmission signal and output the differential transmission signal to the transmission electrode; and
a reception circuit configured to roll back the single-end transmission signal based on the differential received signal received by the reception electrode.

12. The communication system according to claim 1,
wherein the first electrode is a reception electrode, and
wherein the second electrode is a transmission electrode.

13. The communication system according to claim 1, wherein the first electrode is shorter than the second electrode, in the predetermined direction.

14. The communication system according to claim 13, wherein a length of the first electrode in the predetermined direction is equal to or longer than a length between two bent portions of the second electrode in the predetermined direction.

15. The communication system according to claim 12,
wherein the transmission electrode is an electrode of a differential line configured to transmit a differential transmission signal,
wherein the reception electrode is an electrode of a differential line configured to receive a differential received signal, and
wherein the communication system further comprises:
a buffer configured to receive a single-end transmission signal and output the differential transmission signal to the transmission electrode; and
a reception circuit configured to roll back the single-end transmission signal based on the differential received signal received by the reception electrode.

16. A communication device comprising:
a second electrode configured to couple to a first electrode arranged in another communication device by at least one of an electric field and a magnetic field,
wherein the second electrode has two or more bent portions, the two or more bent portions being bent in a direction perpendicular to a predetermined direction, and
wherein a distance between farthest points of the second electrode in the direction perpendicular to the predetermined direction is longer than a distance between farthest points of the first electrode in the direction perpendicular to the predetermined direction.

17. The communication device according to claim 16, wherein the second electrode has a meandering shape.

18. The communication device according to claim 16,
wherein the two or more bent portions of the second electrode include a first bent portion, a second bent portion, and a third bent portion, and
wherein a distance between the first bent portion and the second bent portion in the predetermined direction is substantially the same as a distance between the second bent portion and the third bent portion in the predetermined direction.

19. The communication device according to claim 16, wherein the second electrode is movable in the predetermined direction with respect to the first electrode.
